(19) United States
(12) Patent Application Publication
(10) Pub. No.: US 2006/0162878 A1
(43) Pub. Date: Jul. 27, 2006

(54) Window blind with a resistance-providing unit

(76) Inventor: Paul Lin, Yung-Kang City (TW)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 11/046,046

(22) Filed: Jan. 27, 2005

(51) Int. Cl. B60J 1/20

(52) U.S. Cl. 160/370.22

(57) ABSTRACT

A window blind includes first and second mounting seats, a rotating shaft, a flexible covering body, a biasing mechanism, and a resistance-providing unit. The rotating shaft has opposite first and second end portions coupled rotatably and respectively to the first and second mounting seats, and is operable so as to rotate in a first direction, and a second direction opposite to the first direction. The flexible covering body furls on the rotating shaft when the rotating shaft rotates in the second direction, and unfurls from the rotating shaft when the rotating shaft rotates in the first direction. The biasing mechanism biases the rotating shaft to rotate in the second direction. The resistance-providing unit transmits a frictional force to the rotating shaft when the rotating shaft rotates in the second direction, thereby ensuring smooth furling of the flexible covering body on the rotating shaft.

### BACKGROUND OF THE INVENTION

1. Field of the Invention

The invention relates to a windows blind, more particularly to a window blind that includes a resistance-providing unit to ensure smooth furling of a flexible covering body of the window blind.

2. Description of the Related Art

A conventional window blind includes first and second mounting seats, a rotating shaft, a biasing spring, and a flexible covering body. The rotating shaft has opposite first and second end portions that are coupled rotatably and respectively to the first and second mounting seats, and is operable so as to rotate in a first direction, and a second direction opposite to the first direction. The biasing mechanism is operable so as to bias the rotating shaft to rotate in the second direction. The flexible covering body has a securing end that is secured to the rotating shaft, and a free end that is opposite to the securing end of the flexible covering body. In operation, at an initial position, where the flexible covering body is wound on the rotating shaft, when an external pulling force is applied to the free end of the flexible covering body, this results in corresponding rotation of the rotating shaft in the first direction against biasing action of the biasing spring and in unfurling of the flexible covering body from the rotating shaft. Thereafter, when the free end of the flexible covering body is released from the external pulling force, this results in rotation of the rotating shaft in the second direction due to the biasing action of the biasing spring and in furling of the flexible covering body on the rotating shaft.

Although the aforementioned conventional window blind achieves its intended purpose, upon release of the external pulling force, the rotating shaft, due to the biasing action of the biasing spring, rotates rapidly. This results in undesirable violent furling of the flexible covering body on the rotating shaft.

### SUMMARY OF THE INVENTION

Therefore, the object of the present invention is to provide a window blind that is capable of overcoming the aforementioned drawback of the prior art.

According to the present invention, a window blind comprises first and second mounting seats, a rotating shaft, a flexible covering body, a biasing mechanism, and a resistance-providing unit. The rotating shaft has opposite first and second end portions coupled rotatably and respectively to the first and second mounting seats, and is operable so as to rotate in a first direction, and a second direction opposite to the first direction. The flexible covering body furls on the rotating shaft when the rotating shaft rotates in the second direction, and unfurls from the rotating shaft when the rotating shaft rotates in the first direction. The biasing mechanism serves to bias the rotating shaft to rotate in the second direction. The resistance-providing unit has a rotatable part, and transmits a frictional force to the rotating shaft through the rotatable part of the resistance-providing unit when the rotating shaft rotates in the second direction, thereby ensuring smooth furling of the flexible covering body on the rotating shaft.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the first preferred embodiment of a window blind according to the present invention;

FIG. 2 is a fragmentary sectional view to illustrate a coupling unit of the first preferred embodiment;

FIG. 3 is an enlarged sectional view of the coupling unit of the first preferred embodiment; and

FIG. 4 is a fragmentary sectional view of the second preferred embodiment of a window blind according to the present invention.

### DETAILED DESCRIPTION OF THE PREFERRED EMBODIMENTS

Before the present invention is described in greater detail, it should be noted that like elements are denoted by the same reference numerals throughout the disclosure.

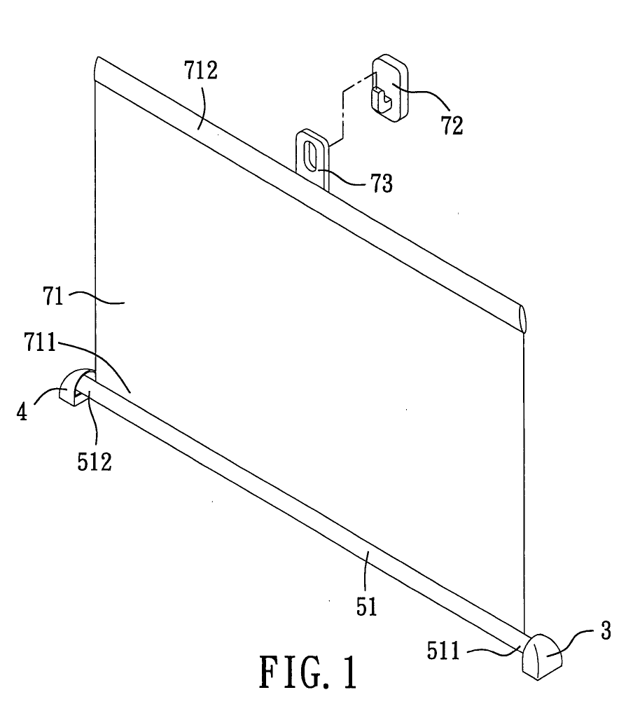

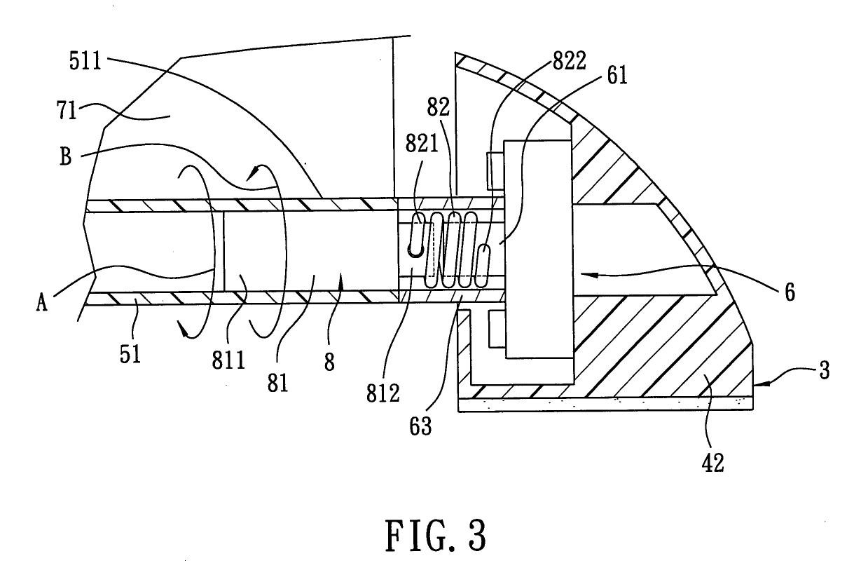

Referring to FIGS. 1 to 3, the first preferred embodiment of a window blind according to this invention is shown to include first and second mounting seats 3, 4, a rotating shaft 51, a flexible covering body 71, a biasing mechanism 54, and a resistance-providing unit 6.

The rotating shaft 51 is tubular, has first and second end portions 511, 512 coupled rotatably and respectively to the first and second mounting seats 3, 4, and is operable so as to rotate in a first direction, as indicated by arrow (A), and a second direction, as indicated by arrow (B), opposite to the first direction.

A centering member 52 has a first end portion 521 that is inserted snugly into the second end portion 512 of the rotating shaft 51, and a second end portion 522 that is opposite to the first end portion 521 of the centering member 52 and that is disposed externally of the rotating shaft 51.

The biasing mechanism 54 is operable so as to bias the rotating shaft 51 to rotate in the second direction. In particular, the biasing mechanism 54 includes a positioning rod 541 and a biasing spring 542. The positioning rod 541 of the biasing mechanism 54 has a first end portion 5411 that is disposed in the rotating shaft 51, and a second end portion 5412 that is opposite to the first end portion 5411 of the positioning rod 541 of the biasing mechanism 54, that extends through the centering member 52, and that is mounted securely to the second mounting seat 4. The biasing spring 542 is sleeved on the first end portion 5411 of the positioning rod 541 of the biasing mechanism 54, and has opposite ends that are connected respectively to the first end portion 5411 of the positioning rod 541 of the biasing mechanism 54 and the first end portion 521 of the centering member 52.

The resistance-providing unit 6 has a rotatable part 61 that is rotatable in the first and second directions. In this embodiment, the resistance-providing unit 6 is a bidirectional damper that has a damper shaft, which serves as the rotatable part 61 of the resistance-providing unit 6. The bidirectional damper 6 generates a frictional force when the damper shaft 61 of the bidirectional damper 6 rotates in the second direction. Since the construction of the bidirectional damper 6 is known to those skilled in that art, a detailed description of the same will be dispensed herein for the sake of brevity.

The window blind further includes a coupling unit 8 that couples the rotating shaft 51 to the damper shaft 61 of the bidirectional damper 6 when the rotating shaft 51 rotates in the second direction. In particular, the coupling unit 8 includes a coupler 81 and a coupling spring 82. The coupler 81 has a first end portion 811 that is inserted snugly into the first end portion 511 of the rotating shaft 51, and a second end portion 812 that is opposite to the first end portion 811 of the coupler 81 of the coupling unit 8 and that is disposed externally of the rotating shaft 51. It is noted that, in this embodiment, the second end portion 812 of the coupler 81 of the coupling unit 8 has a diameter smaller than that of the first end portion 811 of the coupler 81 of the coupling unit 8. The coupling spring 82 of the coupling unit 8 has a first end portion 821 that is sleeved on and that is connected to the second end portion 812 of the coupler 81 of the coupling unit 8, and a second end portion 822 that is opposite to the first end portion 821 of the coupling spring 82 of the coupling unit 8 and that is sleeved on the damper shaft 61 of the bidirectional damper 6.

The window blind further includes a protective tubing 63 that is sleeved on the coupling spring 82. It is noted that the protective tubing 63 maintains alignment between the second end portion 812 of the coupler 81 of the coupling unit 8 and the damper shaft 61 of the bidirectional damper 6.

The flexible covering body 71 has a securing end 711 that is secured to the rotating shaft 51, and a free end 712 that is opposite to the securing end 711 of the flexible covering body 71.

In operation, at a retracted position, where the flexible covering body 71 is furled on the rotating shaft 51, when it is desired to dispose the flexible covering body 71 at an extended position, where the flexible covering body 71 is unfurled from the rotating shaft 51, an external pulling force is applied to the free end 712 of the flexible covering body 71. This results in corresponding rotation of the rotating shaft 51 in the first direction against biasing action of the biasing spring 542 of the biasing mechanism 54, unfurling of the flexible covering body 71 from the rotating shaft 51, and expansion of the coupling spring 82 of the coupling unit 8 in radial outward directions so that rotation of the rotating shaft 51 is not transmitted to the damper shaft 61 of the bidirectional damper 6. Thereafter, when the free end 712 of the flexible covering body 71 is released from the external pulling force, this results in rotation of the rotating shaft 51 in the second direction due to the biasing action of the biasing spring 542 of the biasing mechanism 54, furling of the flexible covering body 71 on the rotating shaft 51, and contraction of the coupling spring 82 of the coupling unit 8 in radial inward directions so that rotation of the rotating shaft 51 is transmitted to the damper shaft 61 of the bidirectional damper 6. As a result, the damper shaft 61 of the bidirectional damper 6 co-rotates with the rotating shaft 51. Since the frictional force generated by the bidirectional damper 6 is transmitted to the rotating shaft 51 through the damper shaft 61 of the bidirectional damper 6, the flexible covering body 71 furls smoothly on the rotating shaft 51.

The window blind further includes a hook element 72, and a hook-engaging element 73 that is provided on the free end 712 of the flexible covering body 71 and that is fastened releasably to the hook element 72 so as to retain the flexible-covering body 71 at the extended position.

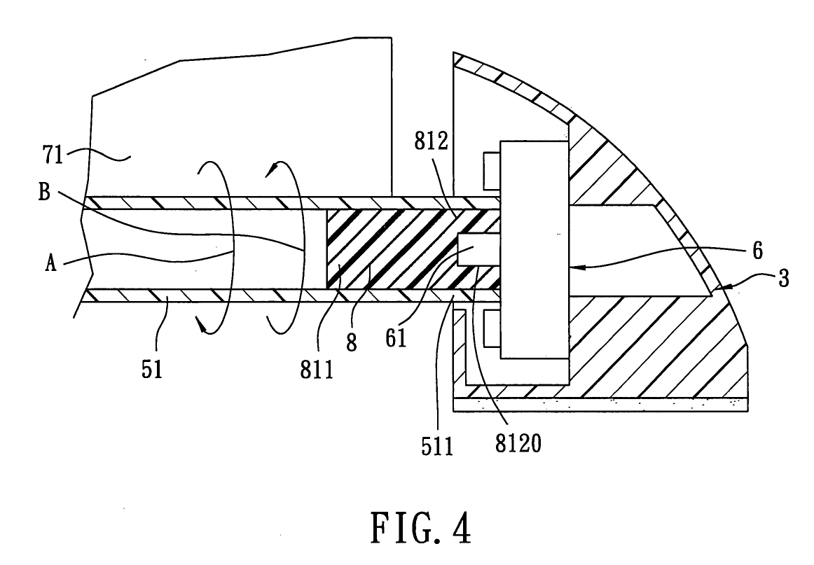

FIG. 4 illustrates the second preferred embodiment of a window blind according to this invention. When compared to the previous embodiment, the resistance-providing unit 6 is a unidirectional damper that has a damper shaft, which serves as the rotatable part 61 of the resistance-providing unit 6. The damper shaft 6 of the unidirectional damper 6 generates a frictional force only when the damper shaft 61 of the unidirectional damper 6 rotates in the second direction. Since the construction of the unidirectional damper 6 is known to those skilled in that art, a detailed description of the same will be dispensed herein for the sake of brevity.

The first and second end portions 811, 812 of the coupler 81 of the coupling unit 8 are inserted snugly into the first end portion 511 of the rotating shaft 51. In this embodiment, the second end portion 812 of the coupler 81 of the coupling unit 8 is formed with an engaging groove 8120 that snugly receives the damper shaft 61 of the unidirectional damper 6.

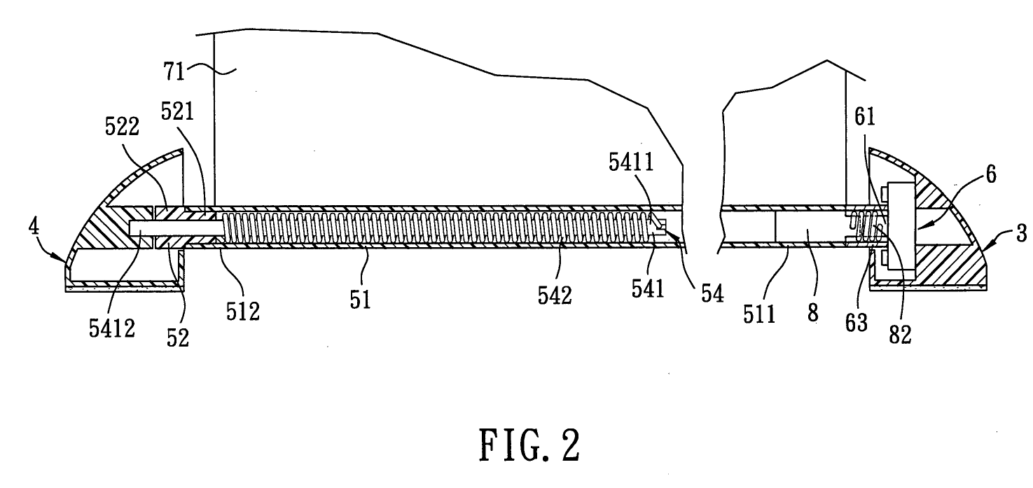

In operation, at the retracted position, when it is desired to dispose the flexible covering body 71 at the extended position, an external pulling force is applied to the free end 712 (see FIG. 1) of the flexible covering body 71. This results in corresponding rotation of the rotating shaft 51 in the first direction against biasing action of the biasing spring 542 (see FIG. 2) of the biasing mechanism 54 and unfurling of the flexible covering body 71 from the rotating shaft 51. Thereafter, when the free end 712 of the flexible covering body 71 is released from the external pulling force, this results in rotation of the rotating shaft 51 in the second direction due to the biasing action of the biasing spring 542 of the biasing mechanism 54 and furling of the flexible covering body 71 on the rotating shaft 51. Since the frictional force generated by the unidirectional damper 6 is transmitted to the rotating shaft 51 through the damper shaft 61 of the unidirectional damper 6, the flexible covering body 71 furls smoothly on the rotating shaft 51.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A window blind, comprising:
first and second mounting seats;
a rotating shaft having opposite first and second end portions coupled rotatably and respectively to said first and second mounting seats, and operable so as to rotate in a first direction, and a second direction opposite to the first direction;
a flexible covering body furling on said rotating shaft when said rotating shaft rotates in the second direction, and unfurling from said rotating shaft when said rotating shaft rotates in the first direction;
a biasing mechanism for biasing said rotating shaft to rotate in the second direction; and
a resistance-providing unit having a rotatable part, said resistance-providing unit generating a frictional force that is transmitted to said rotating shaft through said rotatable part of said resistance-providing unit when said rotating shaft rotates in the second direction, thereby ensuring smooth furling of said flexible covering body on said rotating shaft.

2. The window blind as claimed in claim 1, wherein said resistance-providing unit is a bidirectional damper that has a damper shaft, which serves as said rotatable part of said resistance-providing unit,
said window blind further comprising a coupling unit for coupling said rotating shaft to said damper shaft of said bidirectional damper when said rotating shaft rotates in the second direction, said coupling unit including a coupler that is coupled to said rotating shaft, and a coupling spring that is sleeved on and that is coupled to said coupler, and that is sleeved on said damper shaft of said bidirectional damper,
wherein rotation of said rotating shaft in the first direction results in expansion of said coupling spring in radial outward directions so that rotation of said rotating shaft is not transmitted to said damper shaft of said bidirectional damper, and
wherein rotation of said rotating shaft in the second direction results in contraction of said coupling spring in radial inward directions so that rotation of said rotating shaft is transmitted to said damper shaft of said bidirectional damper.

3. The windows blind as claimed in claim 1, wherein said resistance-providing unit is a unidirectional damper that has a damper shaft, which serves as said rotatable part of said resistance-providing unit,
said window blind further comprising a coupling unit for coupling said rotating shaft to said damper shaft of said unidirectional damper.
